(19) United States
(12) Patent Application Publication
(10) Pub. No.: US 2026/0214517 A1
(43) Pub. Date: Jul. 23, 2026

(54) QUALITY OF EXPERIENCE IN HANDOVER

(71) Applicant: ZTE CORPORATION, Shenzhen, Guangdong (CN)

(72) Inventors: Zhuang LIU, Shenzhen (CN); Yansheng LIU, Shenzhen (CN); Man ZHANG, Shenzhen (CN); Jiajun CHEN, Shenzhen (CN); Dapeng LI, Shenzhen (CN); Yin GAO, Shenzhen (CN)

(21) Appl. No.: 19/134,981

(22) PCT Filed: Jun. 25, 2023
(86) PCT No.: PCT/CN2023/102190

§ 371 Date: Jun. 2, 2025

(51) Int. Cl. H04W 36/00; H04L 41/5067

(52) U.S. Cl. CPC H04W 36/0058; H04L 41/5067; H04W 36/0016; H04W 36/0079

(57) ABSTRACT

A wireless communication method includes: receiving, during handover, a target quality of experience (QoE) information and a quality of experience (QoE) assistance information; generating a predicted QoE information based on the QoE assistance information; and determining whether a target QoE can be satisfied after the handover based on the predicted QoE information with the target QoE information.

### CROSS-REFERENCE TO RELATED APPLICATION(S)

This application is a national phase entry under 35 USC 371 of International Patent Application No. PCT/CN2023/102190 filed on Jun. 25, 2023, and the entire content of the International Patent Application is incorporated into this application by reference.

### TECHNICAL FIELD

This document is directed generally to wireless communications. More specifically, in a mobile device communications system, there may be improved handover of user equipment (UE) using a quality of experience (QoE).

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfill the requirements from different industries and users. User mobile stations or user equipment (UE) are becoming more complex and the amount of data communicated continually increases.

### SUMMARY

In one embodiment, a wireless communication method includes receiving, during handover, a target quality of experience (QoE) information and a quality of experience (QoE) assistance information; generating a predicted QoE information based on the QoE assistance information; and determining whether a target QoE can be satisfied after the handover based on the predicted QoE information with the target QoE information. The receiving, generating, and determining are by a target basestation. The handover comprises a user equipment (UE) transitioning from a source basestation to the target basestation. During handover, the receiving the QoE information is sent by the source basestation either directly or through a core network (CN). The target QoE comprises at least a target QoE value of one service for the UE. The QoE assistance information comprises at least one of: a position of the UE, a downlink signal quantities measurement results of the UE for a serving cell and neighbor cells, a cell or beam level measurement, interference power measurement of the UE, or current measured QoE results. The source basestation sends an NGAP HANDOVER REQUIRED message to a core network, or the source basestation sends an XnAP HANDOVER REQUEST message to the target basestation, wherein the HANDOVER REQUEST message comprises the target QoE information and the QoE assistance information. The core network sends a NAGP HANDOVER REQUEST message to the target basestation that comprises the target QoE information, or the QoE assistance information. The method includes determining, by the target basestation, when the target QoE of the UE cannot be met after handover; and sending, by the target basestation, a handover failure message to the source basestation based on the determining that the target QoE cannot be met. The sending to the source basestation is directly, or through a core network (CN). The handover failure message comprises predicted QoE information or a cause value for target QoE that cannot be met. The handover failure message comprises an NGAP HANDOVER FAILURE message, or an XnAP HANDOVER PREPARATION FAILURE message. The method includes determining, by the target basestation, when the target QoE of the UE can be met after handover; and sending, by the target basestation, a handover success message to the source basestation based on the determining that the target QoE can be met. The sending to the source basestation is directly, or through a core network (CN). The handover success message comprises predicted QoE information. The predicted QoE information comprises at least a predicted value of the QoE of one service of the UE after handover. The handover success message comprises an NGAP HANDOVER REQUEST ACKNOWLEDGE message, or an XnAP HANDOVER REQUEST ACKNOWLEDGE message.

In another embodiment, a wireless communication method includes receiving quality of experience (QoE) trigger condition in a successful handover report (SHR) configuration; and generating the SHR based on the QoE trigger condition. A user equipment (UE) receives the QoE trigger condition from a basestation and the generating the SHR is by the UE. The method includes sending the generated SHR to the basestation configuring the QoE trigger condition in the SHR configuration directly or via another basestation. The QoE trigger condition comprises target QoE information or predicted QoE information, wherein the target QoE information indicates at least a target value of QoE for one service of the UE, further wherein the predicted QoE information indicates at least a predicted value of QoE for one service of the UE after handover. After handover and upon detecting the QoE trigger condition in the SHR configuration is triggered, the SHR comprises a cause value to indicate the predicted QoE or the target QoE is not met after handover, or a measured QoE after the handover. The triggering comprises when the measured QoE of one or more services does not meet the target QoE, or when the measured QoE of one or more services does not meet the predicted QUE.

In another embodiment, a wireless communication method includes receiving a handover request; and providing, during a handover process in response to the received handover request, a predicted quality of experience (QoE) information. The handover process comprises transitioning a user equipment (UE) from a source basestation to a target basestation. The method includes predicting a QoE measurement with the target basestation after the handover process is complete. The method includes utilizing machine learning with the QoE information.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, and the code, when executed by a processor, causes the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a network architecture of a basestation Central Unit (CU) and basestation Distributed Unit (DU).

FIG. 4 shows an embodiment of user equipment (UE) intra-DU mobility.

FIG. 5 shows an embodiment of user equipment (UE) intra-CU and inter-DU mobility.

FIG. 6 shows an embodiment of user equipment (UE) inter-CU mobility.

FIG. 7A shows an example NG-based handover process with a target basestation predicting QoE.

FIG. 7B shows an example of handover failure from the handover in FIG. 7A.

FIG. 7C shows an example handover success process from the handover in FIG. 7A.

FIG. 8A shows an example Xn-based handover process with a target basestation predicting QoE.

FIG. 8B shows an example of handover failure from the handover in FIG. 8A.

FIG. 8C shows an example handover success process from the handover in FIG. 8A.

FIG. 9 shows an example NG-based handover process with a source basestation predicting QoE.

FIG. 10 shows an example Xn-based handover process with a source basestation predicting QoE.

FIG. 11 shows an example successful handover report (SHR) communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

A user equipment (“UE”) device may move between nodes or cells in which case a handover or a change/addition operation may occur to improve network reliability for the UE as it moves. The movement may be from a source cell to a target cell based on a number of potential target cells that are referred to as candidate cells. The movement between cells may also include a number of target cells that are potential candidate cells. The handover may include a conditional handover (“CHO”) or a conditional PSCell addition/change (“CPAC”). The CPAC may include a conditional PSCell change (“CPC”) and/or a conditional PSCell (Primary Secondary Cell) addition (“CPA”). A CHO is a handover that is executed by the UE when one or more execution conditions are met. The UE can evaluate the execution condition(s) upon receiving the CHO configuration, and can stop evaluating the execution condition(s) once the handover is triggered. A conditional PSCell addition/change (“CPAC”) may include the UE having a network configuration for initiating access to a candidate PSCell.

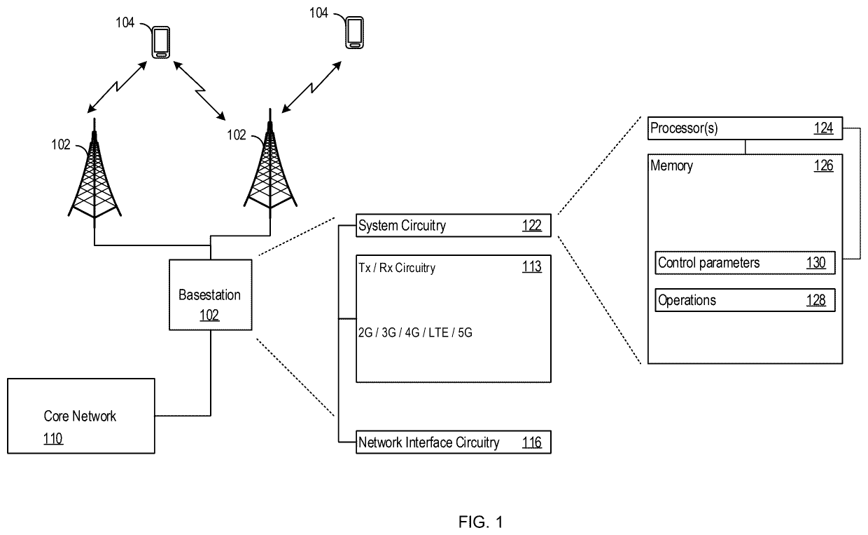

The UE in the wireless network can operate in dual connectivity (“DC”), including intra-E-UTRA DC or Multi-Radio DC (“MR-DC”). In the example of intra-E-UTRA DC, both the MN and SN provide E-UTRA (Evolved Universal Terrestrial Radio Access) access. While in the example of MR-DC, one node may provide new radio (“NR”) access and the other one provides either E-UTRA or NR access. As described below with respect to FIGS. 1-6, a network provider may include a number of network nodes (i.e., basestations) for providing network access to a user equipment (“UE”) device. The network nodes are referred to as basestations in some embodiments. FIGS. 4-6 illustrate a handover in which the UE device moves between cells facilitated by control signaling. The handover (HO) may also be referred to as cell mobility.

A successful handover (HO) report (SHR) may be used to optimize the timers during the handover process to avoid executing the handover too early or too late, which can improve the success rate of the handover. During the handover process, it may be necessary to avoid reducing the quality of service for the UE. In other words, the Quality of Experience (QoE) should not be negatively impacted. For example, although the UE is successfully handed over to the target cell, if the QoE of the UE decreases or does not meet user needs, then that may be considered a failure. As described below, the QoE can be utilized to improve the handover process.

This may address issues where during a successful handover, some SHR triggering condition(s) are met, but there are other conditions that are not met and result in problems. For a successful HO from a source basestation cell to a target basestation cell, the network can configure the SHR triggering condition(s) to the UE before the handover. If the configured SHR triggering condition(s) have been met upon the successful handover procedure with the target cell, the UE generates the SHR, and then the UE can report the SHR to the network. The network can use the SHR to optimize the mobility robustness.

The Quality of Experience (QoE) measurement can be defined based on different applications and measurements at the UE's application layer, including the measurement of throughput, data loss, latency, etc. This may include end to end customers'experience of the services. QoE information collection for a UE may provide detailed information at service/session level on a UE, and initiated/configured by an operator at the service/session starting.

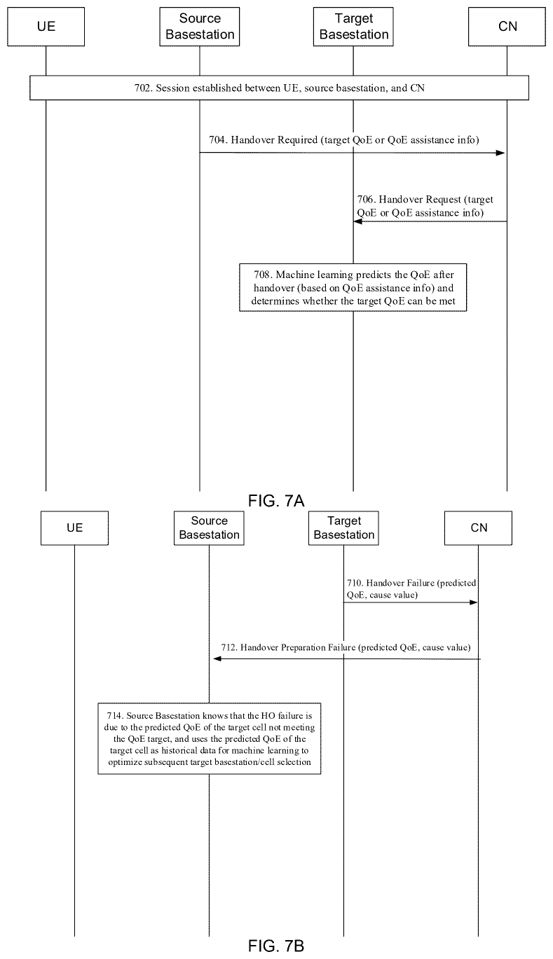

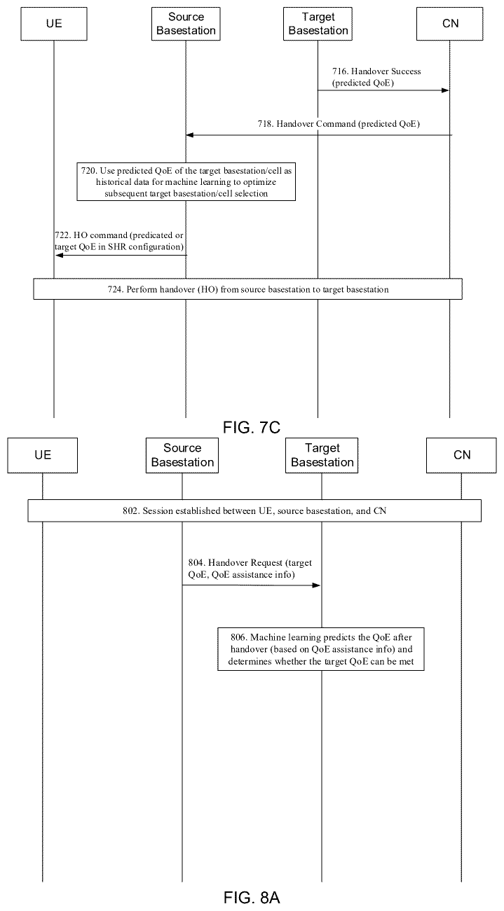

FIG. 1 shows an example basestation 102. The basestation may also be referred to as a wireless network node and may be the network nodes (e.g. master node (“MN”), secondary node (“SN”), and the source/target nodes (also referred to as a source/target basestation)) shown in FIGS. 7A-7B. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning of the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

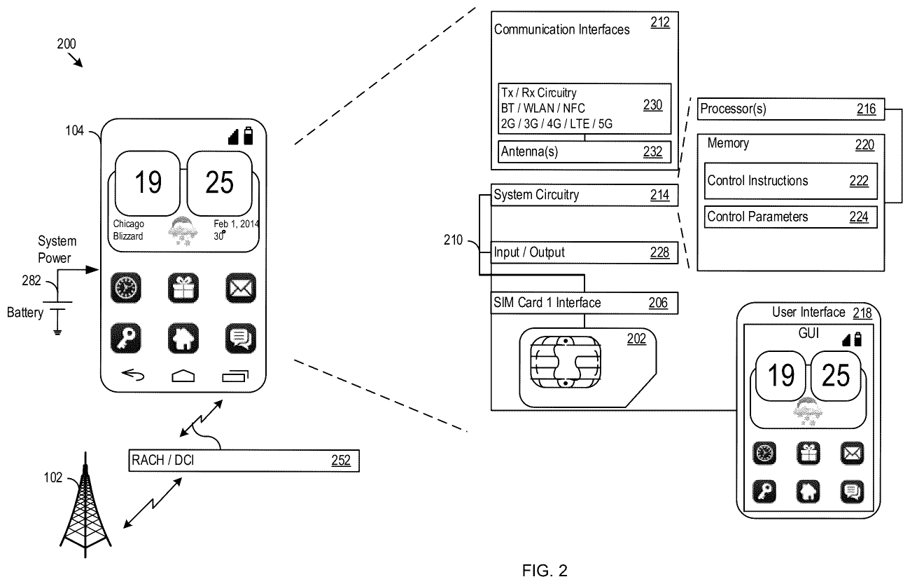

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface (also referred to as an SIM card 1 interface) 206 connects SIM1 202 to the rest of the user equipment hardware, for example, through the system bus 210.

The mobile device (UE 104) includes communication interfaces 212, system logic (also referred to as a system circuitry) 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs/output 228 may include a graphical user interface, touch sensitive display, haptic feedback or other haptic output, voice or facial recognition inputs, buttons, switches, speakers and other user interface elements. Additional examples of the inputs/output 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282.

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G /Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U(MN) interface instance.

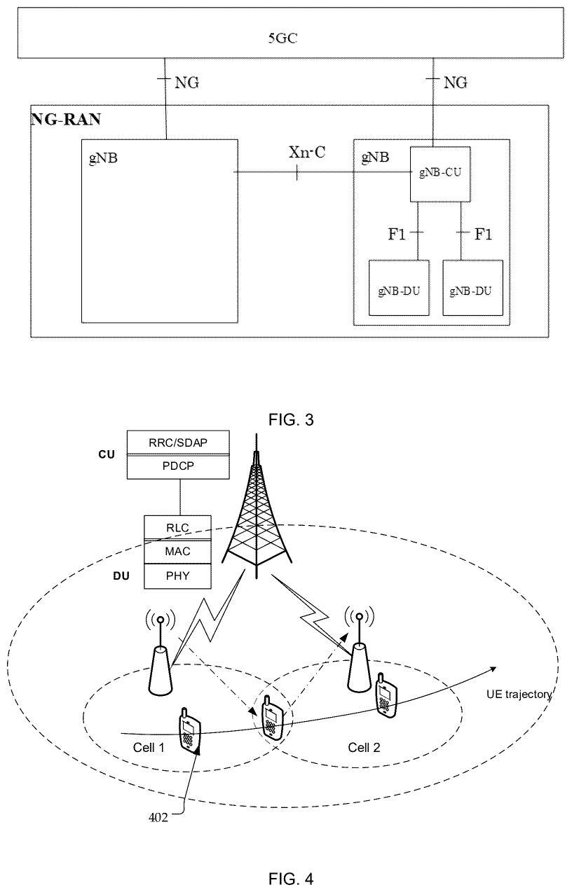

FIG. 3 shows a network architecture of a basestation Central Unit (CU) and basestation Distributed Unit (DU). FIG. 3 illustrates basestations (labeled as “gNB”) that communicate with an overall network (labeled (“5GC”). Basestations can communicate with one another via a control plane interface (“Xn-C”). One basestation is shown as having one CU that is connected to two DUs via an F1 interface. This is merely one example of an arrangement of a basestation. In some embodiments, there may be one or any number of DUs connected with a single CU.

The basestation can be divided into two physical entities named Centralized Unit (“CU”) and Distributed Unit (“DU”). Generally, the CU may provide support for the higher layers of the protocol stack such as SDAP (Service Data Adaptation Protocol), PDCP and RRC while the DU provides support for the lower layers of the protocol stack such as RLC (Radio Link Control), MAC (Media Access Control) and Physical layer. The CU may include operations for a transfer of user data, mobility control, radio access network sharing, session management, etc., except those functions allocated exclusively to the DU. The DU(s) are logical node(s) with a subset of the basestation functions, and may be controlled by the CU.

The CU may be a logical node hosting RRC, SDAP and PDCP protocols of the basestation or RRC and PDCP protocols of the basestation that controls the operation of one or more DUs. The DU may be a logical node hosting RLC, MAC and PHY layers of the basestation, and its operation may be at least partly controlled by the CU. A single DU may support one or multiple cells. However, each cell is only supported by a single DU. Each basestation may support many cells. As described in the embodiments herein, the cell mobility between cells may be from different CUs or DUs or may be internal to the CU and/or the DU.

The inter-cell mobility described herein may occur in a number of different examples. There may be intra-DU mobility where a UE changes cells within a single DU. Examples of intra-DU mobility include: 1) PCell change within one DU (may also include PCell change with SCell change); 2) PSCell change within one DU (may also include PSCell change with SCell change); and 3) PCell change within one DU with PSCell change within one DU (may also include SCell change within one cell group). In another mobility embodiment, there may be intra-CU and inter-DU mobility where a UE changes cells between different DUs but within a single CU. Examples of intra-CU and inter-DU mobility include: 1) PCell change across DU but within one CU (may also include PCell change with SCell change); and 2) PSCell change across DU but within one CU (may also include PSCell change with SCell change). In another mobility embodiment, there may be inter-CU mobility where a UE changes cells between different CUs. Examples of inter-CU mobility include: 1) PCell change across CU (may also include PCell change with SCell change); and 2) PSCell change across CU (may also include PSCell change with SCell change). In another embodiment, there may be a SCell change/addition and this example may include the SCell addition/change within one cell group. FIGS. 4-6 illustrate embodiments of UE mobility between cells.

FIG. 4 shows an embodiment of user equipment (UE) intra-DU mobility. The basestation may include a CU and at least one DU. In this embodiment, there is a single DU shown that has multiple cells. Both Cell_1 and Cell_2 are from the single DU. In this example, the UE 402 can move from Cell_1 to Cell_2 and is depicted in FIG. 4 with a UE trajectory from Cell_1 to Cell_2. The mobility from cells may occur when the UE 402 is in a position between the two cells and making its way to the third position within Cell_2. This is intra-DU mobility because the UE is moving cells within a single DU.

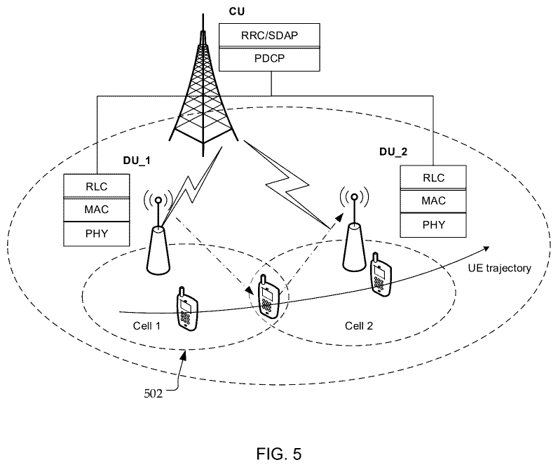

FIG. 5 shows an embodiment of user equipment (UE) intra-CU and inter-DU mobility. In this embodiment, the basestation may include a CU and two DUs (DU_1 and DU_2). Although each DU may have multiple cells, for this example each DU is shown providing a single cell such that DU_1 is providing Cell_1 and DU_2 is providing Cell_2. In this example, the UE 502 can move from Cell_1 to Cell_2 and is depicted in FIG. 5 with a UE trajectory from Cell_1 to Cell_2 which also results in a transition from DU_1 to DU_2. The mobility from cells may occur when the UE 402 is in a position between the two cells and making its way to the third position within Cell_2. This is intra-CU mobility because the UE is moving cells within a single CU. However, this is also inter-DU mobility because the UE is moving between different DUs.

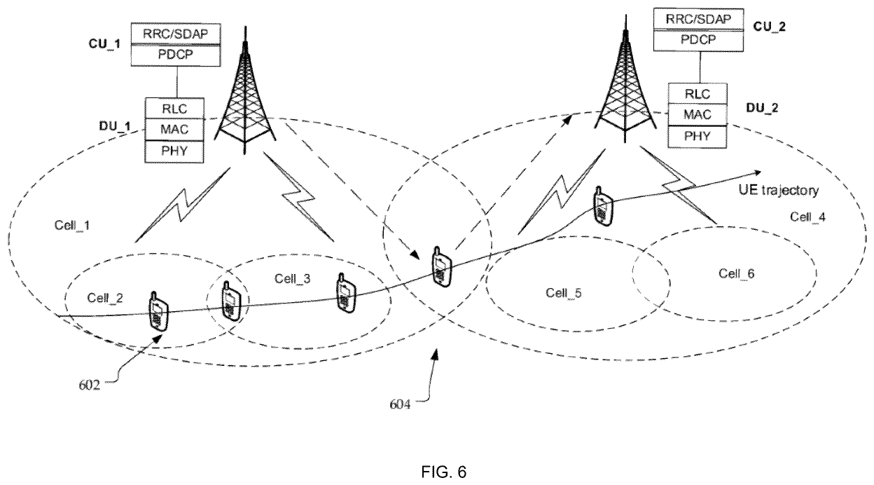

FIG. 6 shows an embodiment of user equipment (UE) inter-CU mobility. In this embodiment, the basestation may include multiple CUs (CU_1 and CU_2). Each CU may include multiple DUs, but in this example, each CU is shown as having one corresponding DU (CU_1 has DU_1 and CU_2 has DU_2). Each of the DUs is shown with multiple cells. In this example, the UE trajectory of the UE 602 passes from Cell_2 to Cell_3 to an inter-CU position 604 (between CU_1 and CU_2) to Cell_5 and Cell_6. As the UE moves, the mobility may change cells as shown and may transition between a number of cells. Because the UE 602 (at the inter-CU position 604) switches cells from CU_1 to CU_2, this transition is referred to as inter-CU mobility.

The embodiments described below with respect to FIGS. 7A-11, illustrate embodiments that improve a quality of experience (QoE) by using QoE information and predictions for handover. As described, the handover may include the UE transitioning from a source basestation to a target basestation.

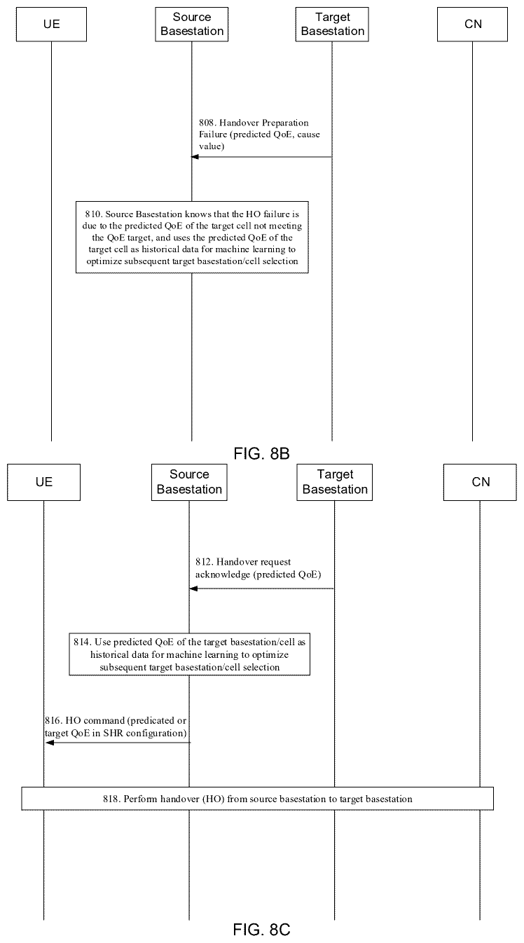

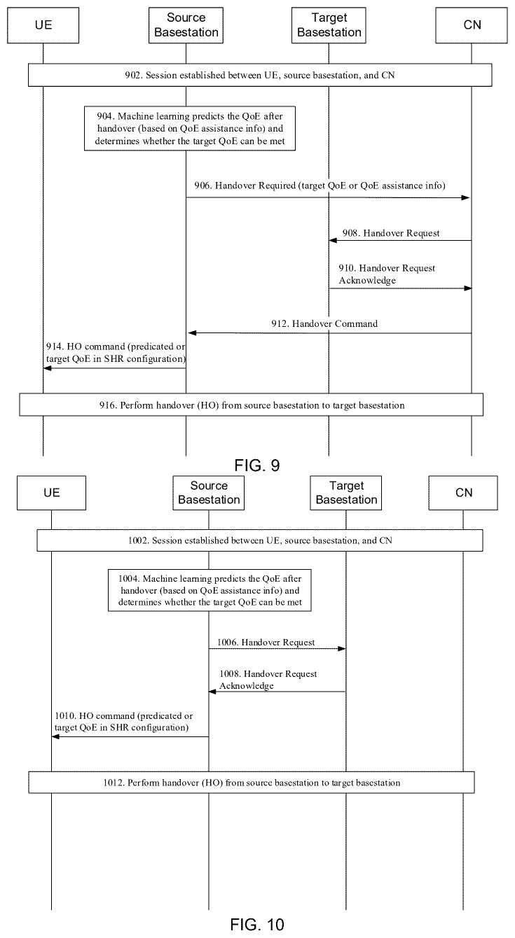

FIG. 7A shows an example NG-based handover process with a target basestation predicting QoE. In this example of a next generation (NG) handover, there may not be an Xn interface between the source basestation and the target basestation. Conversely, FIGS. 8A-8C and 10 illustrate an alternate example with an Xn interface between the source basestation and the target basestation. In FIGS. 7A-8C, the target basestation provides the predicted QoE (hereinafter also referred to as predicted QoE information) while FIGS. 9-10 illustrate the source basestation providing the predicted QoE.

In block 702, the UE connects with the source basestation which provides services to the UE. This session is between the UE, the source basestation, and the core network (CN). During UE mobility, the source basestation may identify a target basestation for handover. If there is no interface connection (Xn interface) between the source basestation and the target basestation, the source basestation sends HANDOVER REQUIRED message to the CN in block 704 to request the preparation of resources at the target basestation. This may include at least one of the following information in the message target QoE information or QoE assistance information.

The target QoE information indicates the target value(s) of the QoE of one or more services of the UE. A target value of the QoE may be a subset of target QoE metrics for UE for one service (e.g., target packet Round-trip time, target Jitter duration time, target throughput, target initial playout delay for video, target video resolution, target buffer occupancy level, etc.). There may be a target QoE Score for one service, where the target QoE score could be a number in a range (e.g., 0 to 10, where 10 represents excellent quality and 0 represents poor quality). Alternatively, the target QoE score could be an enumerated type to indicate the target QoE quality (e.g., poor, medium, good, etc.).

The QoE assistance information includes at least one of following: UE position, downlink (DL) signal quantities measurement results of the UE for the serving cell and neighbor cells, including cell/beam level measurement, received interference power measurement of the UE, current measured QoE results (e.g., UE's RAN visible QoE (RVQoE) report).

After receiving the HANDOVER REQUIRED message from the source basestation, the CN sends HANDOVER REQUEST message in block 706 via an NG interface to the target basestation. This message includes the received target QoE information and/or the received QoE assistance information. After receiving the HANDOVER REQUEST message from the CN, the target basestation allocates the resources for the UE. Based on the received QoE assistance information (e.g., UE position, DL signal quantities, and received interference power), the target basestation can use machine learning and/or artificial intelligence to predict the QoE of service(s) of the UE after handover. This can be used to determine whether the target QoE can be met. The machine learning includes providing data about the targets and QoE information for improving prediction. An example of a failure of handover is illustrated in FIG. 7B, and an example of a successful handover is illustrated in FIG. 7C.

FIG. 7B shows an example of handover failure from the handover in FIG. 7A. This example may be a continuation of the steps from FIG. 7A. After the target basestation predicts the QoE of service(s) of the UE after handover, and if the target basestation determines the target QoE of UE cannot be met after handover, then the target basestation sends a HANDOVER FAILURE message to the CN in block 710. This message may include at least one of the following in the message: predicted QoE information or a cause value.

The predicted QoE information indicates the predicted value(s) of the QoE of one or more services of the UE after handover. A predicted value of the QoE is a subset of predicted QoE metrics for UE for one service (e.g. predicted packet round-trip time, predicted jitter duration time, predicted throughput, predicted initial playout delay for video, target video resolution, predicted buffer occupancy level, etc., and/or a predicted QoE Score for one service. The predicted QoE score could be a number in range (e.g., 0 to 10, where 10 represents excellent quality and 0 represents poor quality), or the predicted QoE score could be an enumerated type to indicate the predicted QoE quality (e.g., poor, medium, good, etc.). The cause value is used to indicate the handover failure is caused when the target QoE of UE cannot be met.

In block 712, the CN sends the HANDOVER PREPARATION FAILURE message to the source basestation, including at least one of the following in the message: predicted QoE information and/or cause value. In block 714, the source basestation knows that the handover failure is due to the predicted QoE information of the target cell not meeting the QoE target of the UE, and stores the predicted QoE of the target cell as historical data to optimize subsequent target basestation/cell selection for handover UEs.

FIG. 7C shows an example handover success process from the handover in FIG. 7A. This example may be a continuation of the steps from FIG. 7A. After the target basestation predicts the QoE of service(s) of the UE after handover, and if the target basestation determines the target QoE of UE can be met after handover, then the target basestation sends a HANDOVER SUCCESS message to the CN in block 716. The message may also be referred to as a HANDOVER REQUEST ACKNOWLEDGE message to the CN, including the following in the message: predicted QoE information that indicates the predicted value(s) of the QoE of one or more services of the UE after handover.

In block 718, the CN sends the HANDOVER COMMAND message to the source basestation to inform the source basestation that resources for the handover have been prepared at the target side (or referred to as a target basestation), including the predicted QoE information. In block 720, the source basestation stores the predicted QoE information of the target cell as historical data to optimize subsequent target basestation/cell selection for handover UEs. In block 722, the source basestation sends an RRC RECONFIGURE message (e.g. HO command) to the UE to inform the UE to perform the handover from the source basestation to the target basestation. The message may include the SHR configuration within the message and include the predicted QoE information and/or the target QoE information. In block 724, the UE performs handover from the source basestation to the target basestation.

FIG. 8A shows an example Xn-based handover process with a target basestation predicting QoE. In this example of an Xn-based handover, there is an Xn interface between the source basestation and the target basestation, which may simplify communications since the source basestation and target basestation can communicate. Specifically, this allows the source basestation to directly send a HANDOVER REQUEST to the target basestation via the Xn interface as in block 804. This is after the UE has connected with the source basestation which provides services to UE as in block 802.

During the UE mobility, the source basestation decides a target basestation for handover. With the Xn interface connection between the source basestation and the target basestation, the source basestation sends the HANDOVER REQUEST message to the target basestation in block 804. This message requests the preparation of resources at the target basestation, including at least target QoE information and/or QoE assistance information. The target QoE information indicates the target value(s) of the QoE of one or more services of the UE. The QoE assistance information includes at least one of following: UE position, DL signal quantities measurement results of the UE for the serving cell and neighbor cells, including cell/beam level measurement, or received interference power measurement of the UE.

After receiving the HANDOVER REQUEST message from the source basestation, the target basestation allocates the resources for the UE. Based on the received QoE assistance information (e.g. UE position, DL signal quantities, and/or received interference power), the target basestation can use Al/machine learning to predict the QoE of service(s) of the UE after handover in block 806 and then determine whether the target QoE can be met.

FIG. 8B shows an example of handover failure from the handover in FIG. 8A. This example may be a continuation of the steps from FIG. 8A. After the target basestation predicts the QoE of service(s) of the UE after handover, and if the target basestation determines the target QoE of UE cannot be met after handover, then the target basestation sends a HANDOVER PREPARATION FAILURE message to the source basestation in block 808. This message may include predicted QoE information or a cause value. The predicted QoE information indicates the predicted value(s) of the QoE of one or more services of the UE after handover. The cause value is used to indicate the handover failure is caused by the target QoE of UE not being met. In block 810, the source basestation knows that the handover failure is due to the predicted QoE information of the target cell not meeting the QoE target of the UE, and stores the predicted QoE of the target cell as historical data to optimize subsequent target basestation/cell selection for handover UEs.

FIG. 8C shows an example handover success process from the handover in FIG. 8A. This example may be a continuation of the steps from FIG. 8A. After the target basestation predicts the QoE of service(s) of the UE after handover, if the target basestation determines the target QoE can be met after handover, then the target basestation sends HANDOVER REQUEST ACKNOWLEDGE message to the source basestation in block 812. The message includes the predicted QoE information. The predicted QoE information indicates the predicted value(s) of the QoE of one or more services of the UE after handover.

The source basestation stores the predicted QoE information of the target cell as historical data to optimize subsequent target basestation/cell selection for handover UEs in block 814. In block 816, the source basestation sends RRC RECONFIGURE message (i.e. HO command) to the UE to inform the UE to perform the handover from the source basestation to the target basestation. The SHR configuration within the message may include the predicted QoE information and/or the target QoE information. The UE then performs handover from the source basestation to the target basestation in block 818.

FIG. 9 shows an example NG-based handover process with a source basestation predicting QoE. FIGS. 9-10 illustrate the source basestation providing the predicted QoE rather than the target basestation providing the predicted QoE as in FIGS. 7A-8C. In this example embodiment, the source basestation first predicts the QoE of the UE after handover. If the predicted QoE meets the target QoE, then the source basestation informs the target basestation to proceed with the handover. In block 902, the UE is connected with the source basestation which provides services to UE. In block 904, during the UE mobility, the source basestation decides a target basestation for handover. Based on the measured QoE UE position, measured DL signal quantities, and/or measured received interference power, the source basestation can use Al or machine learning to predict the QoE of service(s) of the UE after handover, and to determine whether the target QoE can be met.

In block 906, if the target QoE can be met, and there is no interface connection (Xn interface) between the source basestation and the target basestation, the source basestation sends HANDOVER REQUIRED message to the CN to request the preparation of resources at the target basestation. After receiving the HANDOVER REQUIRED message from the source basestation, the CN sends HANDOVER REQUEST message via NG interface to the target basestation in block 908. After receiving the HANDOVER REQUEST message from the CN in block 908, the target basestation allocates the resources for the UE, then the target basestation sends HANDOVER REQUEST ACKNOWLEDGE message to the CN in block 910. The CN sends the HANDOVER COMMAND message to the source basestation in block 912 to inform the source basestation that resources for the handover have been prepared at the target side. The source basestation sends RRC RECONFIGURE message (i.e. HO command) to the UE in block 914 to inform the UE to perform the handover from the source basestation to the target basestation. This may include at least one of the following in the SHR configuration within the message: the predicted QoE information and/or the target QoE information. The UE performs handover from the source basestation to the target basestation in block 916.

FIG. 10 shows an example Xn-based handover process with a source basestation predicting QoE. FIG. 10 may be similar to FIG. 9 except there is an Xn interface between the source basestation and the target basestation. In this example embodiment, the source basestation first predicts the QoE of the UE after handover. If the predicted QoE meets the target QoE, then the source basestation informs the target basestation to proceed with the handover.

In block 1002, the UE has connected with the source basestation which provides services to UE. During the UE mobility, the source basestation decides a target basestation for handover. Based on the measured QoE UE position, measured DL signal quantities, and/or measured received interference power, the source basestation can use Al or machine learning to predict the QoE of service(s) of the UE after handover in block 1004. This can be used to determine whether the target QoE can be met.

If the target QoE can be met, then the source basestation sends HANDOVER REQUEST message to the target basestation to request the preparation of resources at the target basestation. The source basestation sends the HANDOVER REQUEST message to the target basestation in block 1006. After receiving the HANDOVER REQUEST message from the source basestation, the target basestation allocates the resources for the UE, then the target basestation sends a HANDOVER REQUEST ACKNOWLEDGE message to the source basestation in block 1008.

The source basestation sends RRC RECONFIGURE message (i.e. HO command) to the UE in block 1010. The message may inform the UE to perform the handover from the source basestation to the target basestation and may include at least one of the following in the SHR configuration within the message: the predicted QoE information and/or the target QoE information. The UE performs handover from the source basestation to the target basestation in block 1012.

In an alternative embodiment, when the source basestation predicts the QoE (in block 1006) the source basestation can send the predicted QoE information to the target basestation within the HANDOVER REQUEST message. After the handover is completed, the target basestation can receive the QoE measurement results reported by the UE (e.g. RAN visible QoE (RVQoE) report). If the target basestation finds that the QoE measurement result does not meet the QUE predicted by the source basestation, then the target basestation can forward the QoE report (RVQoE report) to the source basestation. The source basestation can use the received information for subsequent handover optimization. This alternative embodiment can avoid reporting SHR.

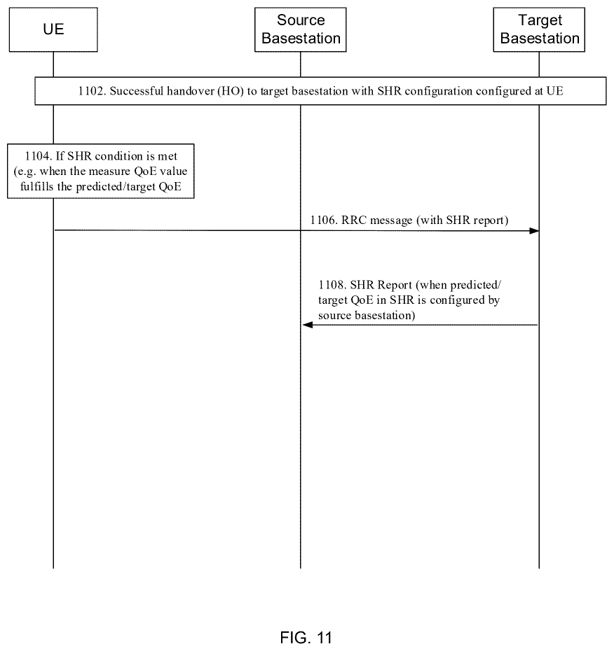

FIG. 11 shows an example successful handover report (SHR) communication. In block 1102, the UE is successfully handed over from the source basestation to the target basestation. During the handover procedure, the QoE trigger condition is configured at the UE (e.g., the target QoE information or the predicted QoE information). After handover, if the UE detects the QoE trigger condition in SHR configuration is triggered (e.g., the measured QoE of one or more services does not meet the target QoE, or the measured QoE of one or more services does not meet the predicted QoE, then the UE generates SHR report (or referred to as SHR) in block 1104. The SHR may include a cause value to indicate that the predicted or the target QoE is not met after handover, and/or the measured QoE after handover. The UE sends the SHR report to the target basestation or another third basestation as in block 1106. The receiving node (the target basestation or another third basestation) determines which node configures the QoE trigger condition in the SHR configuration and forwards the SHR report to that node as in block 1108. The node configuring the QoE trigger condition can use the SHR to optimize the subsequent target cell/basestation selection for handover, ensuring that the QoE of the UE's service(s) after handover also meets user needs.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A wireless communication method comprising:
receiving, during handover, a target quality of experience (QoE) information and a quality of experience (QoE) assistance information;
generating a predicted QoE information based on the QoE assistance information; and
determining whether a target QoE can be satisfied after the handover based on the predicted QoE information with the target QoE information.

2. The method of claim 1, wherein the receiving, generating, and determining are by a target basestation.

3. The method of claim 2, wherein the handover comprises a user equipment (UE) transitioning from a source basestation to the target basestation.

4. The method of claim 3, wherein, during the handover, the receiving the QoE information is sent by the source basestation either directly or through a core network (CN); or
the target QoE comprises at least a target QoE value of one service for the UE; or
the QoE assistance information comprises at least one of: a position of the UE, a downlink signal quantities measurement results of the UE for a serving cell and neighbor cells, a cell or beam level measurement, interference power measurement of the UE, or current measured QoE results.

5-6. (canceled)

7. The method of claim 3, wherein the source basestation sends an NGAP HANDOVER REQUIRED message to a core network, and the core network sends an NAGP HANDOVER REQUEST message to the target basestation that comprises the target QoE information, or the QoE assistance information;
or, the source basestation sends an XnAP HANDOVER REQUEST message to the target basestation, wherein the HANDOVER REQUEST message comprises the target QoE information and the QoE assistance information.

8. (canceled)

9. The method of claim 3, further comprising:
determining, by the target basestation, when the target QoE of the UE cannot be met after handover; and
sending, by the target basestation, a handover failure message to the source basestation based on the determining that the target QoE cannot be met.

10. The method of claim 9, wherein the sending to the source basestation is directly, or through a core network (CN); or
the handover failure message comprises predicted QoE information or a cause value for target QoE that cannot be met; or
the handover failure message comprises an NGAP HANDOVER FAILURE message, or an XnAP HANDOVER PREPARATION FAILURE message.

11-12. (canceled)

13. The method of claim 3, further comprising:
determining, by the target basestation, when the target QoE of the UE can be met after handover; and
sending, by the target basestation, a handover success message to the source basestation based on the determining that the target QoE can be met.

14. The method of claim 13, wherein the sending to the source basestation is directly, or through a core network (CN); or
the handover success message m comprises an NGAP HANDOVER REQUEST ACKNOWLEDGE message, or an XnAP HANDOVER REQUEST ACKNOWLEDGE message.

15. The method of claim 13, wherein the handover success message comprises predicted QoE information; and
the predicted QoE information comprises at least a predicted value of the QoE of one service of the UE after handover.

16-17. (canceled)

18. A wireless communication method comprising:
receiving quality of experience (QoE) trigger condition in a successful handover report (SHR) configuration; and
generating the SHR based on the QoE trigger condition.

19. The method of claim 18, wherein a user equipment (UE) receives the QoE trigger condition from a basestation and the generating the SHR is by the UE.

20. The method of claim 19, further comprising:
sending the generated SHR to the basestation configuring the QoE trigger condition in the SHR configuration directly or via another basestation.

21. The method of claim 18, wherein the QoE trigger condition comprises target QoE information or predicted QoE information, wherein the target QoE information indicates at least a target value of QoE for one service of the UE, further wherein the predicted QoE information indicates at least a predicted value of QoE for one service of the UE after handover.

22. The method of claim 21, wherein after handover and upon detecting the QoE trigger condition in the SHR configuration is triggered, the SHR comprises a cause value to indicate the predicted QoE or the target QoE is not met after handover, or a measured QoE after the handover; and
the triggering comprises when the measured QoE of one or more services does not meet the target QoE, or when the measured QoE of one or more services does not meet the predicted QoE.

23. (canceled)

24. A wireless communication method comprising:
receiving a handover request; and
providing, during a handover process in response to the received handover request, a predicted quality of experience (QoE) information.

25. The method of claim 24, wherein the handover process comprises transitioning a user equipment (UE) from a source basestation to a target basestation.

26. The method of claim 25, further comprising:
predicting a QoE measurement with the target basestation after the handover process is complete.

27. (canceled)

28. A wireless communications apparatus comprising a processor and a memory, wherein the processor is configured to read code from the memory and implement a method recited in claim 1.

29. A computer program product comprising a computer-readable program medium code stored thereupon, the code, when executed by a processor, causing the processor to implement a method recited in claim 1.
